(19) United States
(12) Patent Application Publication
(10) Pub. No.: US 2017/0322781 A1
(43) Pub. Date: Nov. 9, 2017

(54) INTEGRATED DEVELOPMENT ENVIRONMENT FOR CONTROL LANGUAGE OF LEGACY DISTRIBUTED CONTROL SYSTEM

(71) Applicant: Honeywell International Inc., Morris Plains, NJ (US)

(72) Inventors: James M. Schreder, Lansdale, PA (US); Sudharm V. Sangvikar, Bangalore (IN); Ramakrishnan Ganapathi, Bangalore (IN)

(21) Appl. No.: 15/149,022

(22) Filed: May 6, 2016

(51) Int. Cl. G06F 9/44; G06F 9/45

(52) U.S. Cl. CPC G06F 8/33; G06F 8/41

(57) ABSTRACT

This disclosure provides systems and methods for development of legacy control language programs in an integrated development environment. A method includes interacting with a user, by an integrated development environment (IDE) system, to develop and store a control language program in the IDE system. The method includes applying, by the IDE system, one or more control language rules to identify at least one of correct syntax, incorrect syntax, semantics, and programming conventions during the interaction. The method includes displaying, to a user and by the IDE system, results of the application of the control language rules to the control language program during the interaction.

### TECHNICAL FIELD

This disclosure relates generally to improved systems and methods for configuring and programming process control or monitoring systems (collectively, “process control systems”). More specifically, this disclosure relates to systems and methods for an improved integrated development environment for legacy control systems.

### BACKGROUND

Control languages for legacy systems are typically written using editors that do not have a graphical user interface (GUI) and are not user friendly. These editors do not perform syntax and semantic checking. It is complicated to enhance these text editors running in control systems with limited resources. In legacy systems, editors are tightly coupled with the control system and online stations are needed to use the editors. It is very difficult to use such editors, write code, compile, and debug programs compared to the modern editing environments. Further, is difficult for a person who is new to Control Language (CL) development to effectively work with such systems. Improved systems are desirable.

### SUMMARY

This disclosure provides systems and methods for development of legacy control language programs in an integrated development environment. A method includes interacting with a user, by an integrated development environment (IDE) system, to develop and store a control language program in the IDE system. The method includes applying, by the IDE system, one or more control language rules to identify at least one of correct syntax, incorrect syntax, semantics, and programming conventions during the interaction. The method includes displaying, to a user and by the IDE system, results of the application of the control language rules to the control language program during the interaction.

In some embodiments, the IDE system also transmits the control language program to a control system for compilation and receives and displays an indication of result of the compilation. In some embodiments, the IDE system also simulates execution of the control language program. In some embodiments, the IDE system also performs autocomplete functions during the interaction. In some embodiments, the results of the application of the control language rules to the control language program include highlighting the correct syntax, the incorrect syntax, the semantics, and the programming conventions. In some embodiments, the results of the application of the control language rules to the control language program include highlighting related program code or subroutines. In some embodiments, the results of the application of the control language rules to the control language program include highlighting specific characters. In some embodiments, the IDE system also performs block collapse and auto-arrange functions for the control language program.

Other technical features may be readily apparent to one skilled in the art from the following figures, descriptions, and claims. Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may be provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a more detailed view of one example of an IDE system in accordance with disclosed embodiments; and

FIG. 3 illustrates a flowchart of a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Disclosed embodiments include systems and methods for improved programming and configuration of legacy control systems, providing an intelligent, intuitive, and accessible interface to the control system. Various embodiments include such features as on-the-fly syntax checking and keyword highlighting, as described in more detail below.

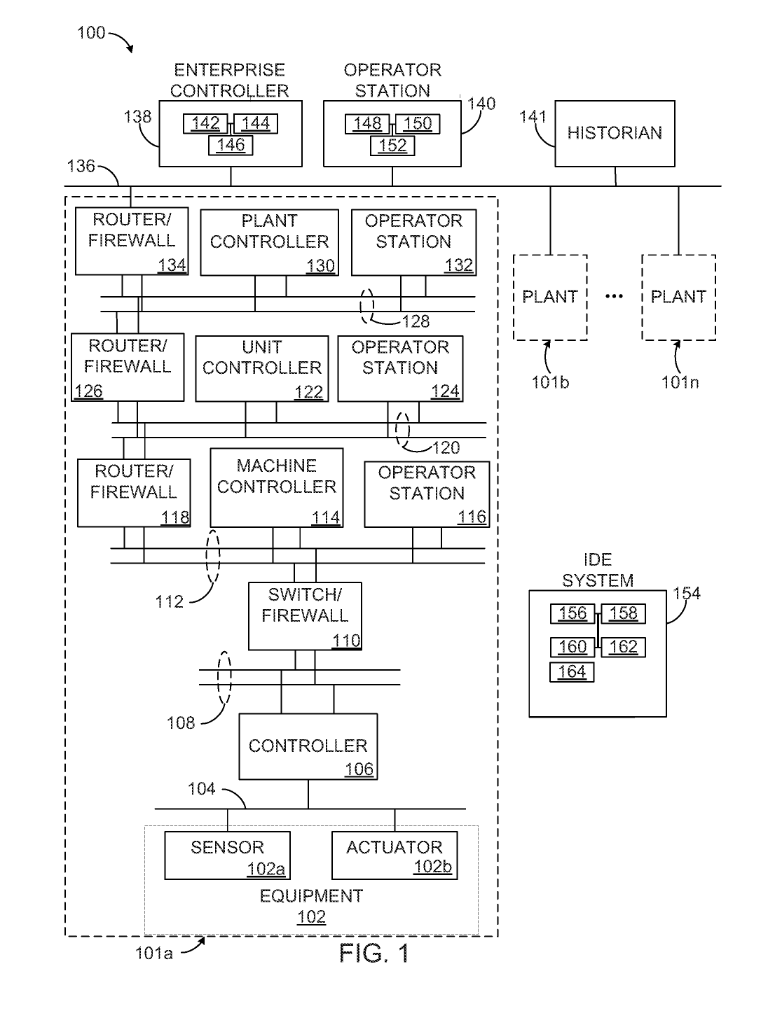

FIG. 1 illustrates an example industrial process control, monitoring, and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b (also, cumulatively, “equipment 102”). The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system. Equipment 102 not intended to be limiting, but include any number of devices or components that can be controlled by system 100, and can include any equipment that can be monitored or controlled by system 100, such as motors, pumps, heat exchangers, turbines, compressors, control valves, other instruments, etc.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system. According to disclosed embodiments, user-written programs as described herein can be executed on the Level 1 controllers.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b). According to disclosed embodiments, user-written programs as described herein can be executed on the Level 2 controllers.

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, actuators 102b, or other equipment 102).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

Disclosed embodiments can provide a modern integrated development environment (IDE) to control systems such as (but not limited to) the industrial process control, monitoring, and automation system 100 described above. This is accomplished (among other ways) using an IDE system 154. Among other things, the IDE system 154 provides an improved interface to a control system, providing a good development user experience. The IDE system 154 includes any suitable structure that is or can be configured to perform processes as disclosed herein. Here, the IDE system 154 includes one or more processing devices 156; one or more memories 158 for storing instructions and data used, generated, or collected by the processing device(s) 156; at least one network interface 160; and a user interface 162 that can include a display, a keyboard, a mouse, and other user interface devices. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory, Flash memory, hard drive, or other computer-readable storage medium. Each network interface 160 could represent an Ethernet interface, wireless transceiver, or other device facilitating external communication. The functionality of the IDE system 154 could be implemented using any suitable hardware or a combination of hardware and software/firmware instructions. The IDE system 154 can further include other data processing system hardware as known to those of skill in the art.

IDE system 154 can use network interface to communicate with one or more of the controllers or other devices of a control system to enable a user to configure and program the device using a IDE that is an improvement on direct programming of the device. The IDE system 154 provides a user friendly environment to support features like syntax highlighting, auto complete, template expansions, block collapse, and auto arrange for control language files, as well as on-line help functions.

IDE system 154 can also perform syntax checking that searches for syntax and semantics errors while editing the control language files in a visually intuitive environment that highlights syntax and semantic errors in the control language as it is being developed, so that issues can be resolved at the earliest opportunity. IDE system 154 can also include a control language rules database 164, stored in a memory 158, that includes syntax, semantic, and other control language rules for one or more specific control languages. As the IDE system 154 interacts with a user to receive control language programming (which can include configurations), the IDE system 154 applies the control language rules to the control language program to identify correct and incorrect syntax and semantics, programming conventions (e.g., matching or mismatched parentheses, braces, or other control language symbols), and other issues particular to each specific control language. The IDE system 154, using the control language rules, can perform syntax highlighting and code completion, functions, methods, loops and other elements. The control language program is stored in the control language files, and these terms may be used interchangeably.

IDE system 154 can also validate external references used in the control language program. For example, in some embodiments, external references include references to other points/objects in the system in the form of Tag.Parameter where Tag is another point/object outside of the point that is hosting and executing the program, and Parameter is reference to a specific attribute or value of the point.

After a control language program/file has been developed in the IDE system 154, the IDE system 154 can interface with the control system to deliver the control language file to be compiled on the control system. When the control language file is compiled by the control system, the IDE system 154 can process and display any to compilation errors or other events generated by the control system.

The IDE system 154 can use the control language rules to simulate execution of the control language files. In doing so, the IDE system 154 can step through the control language program and thereby provide a simple means to create, modify and test the control language program independent of the control system itself.

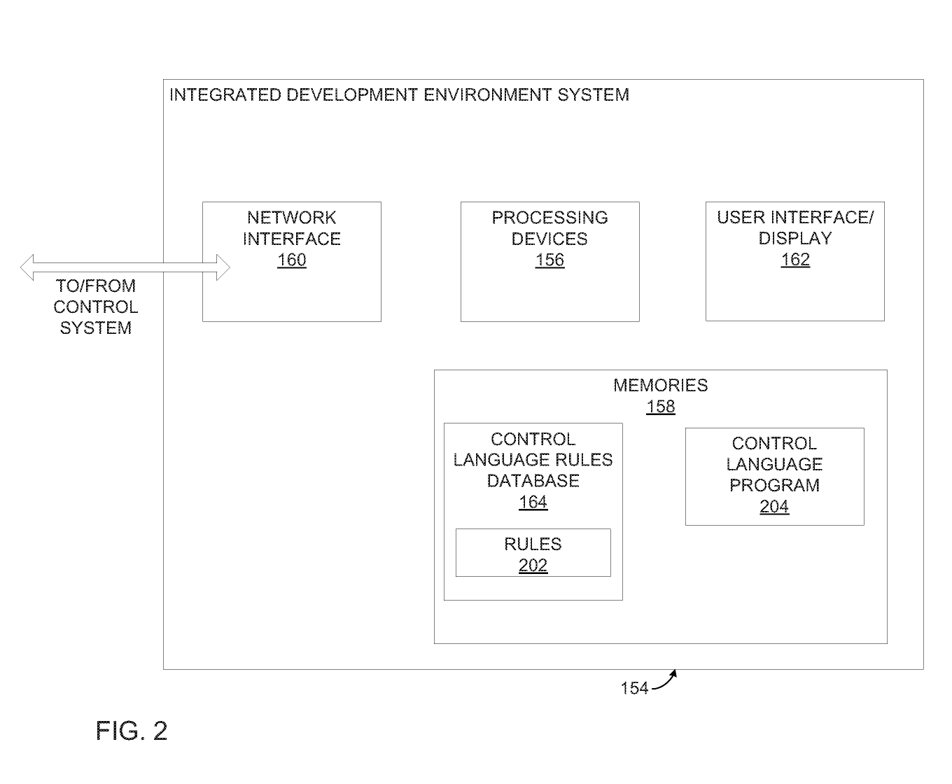

FIG. 2 illustrates a more detailed view of one example of an IDE system 154 in accordance with disclosed embodiments, that can be configured to perform processes as described herein.

FIG. 2 illustrates the IDE system 154, processing devices 156, memories 158, network interface 160, and user interface 162 as described above. One or more of the memories 158 can store such elements as the control language rules database 164 that stores control language rules 202 and the control language program 204. The user interface 162 can be used to interact with a user to develop control language program 204, rules 202, to display a simulated execution of the control language program 204, display errors and other information, and to perform other functions are described herein. The network interface 160 communicates with the control system 100 to perform functions as described herein, including but not limited to sending control language program files to be compiled, sending other configuration data, receiving errors and other information from the control system 100, and others.

IDE system 154 interfaces with the target control system with the control language compiler. In one example, the user on IDE system 154 can, for example. issue a command to compile the control language. The IDE system 154 sends the control language programs written in the IDE environment to the target control system and the compiler running in the control system compiles the control language programs. Using this interface, compilers on legacy control systems can be reused and need not be re-written to comply with modern systems.

In such an example, once the control language programs are compiled in the target control system, the IDE system 154 interface also deploys any other needed elements, such as the control language object files, to the appropriate controllers or other devices of the control system.

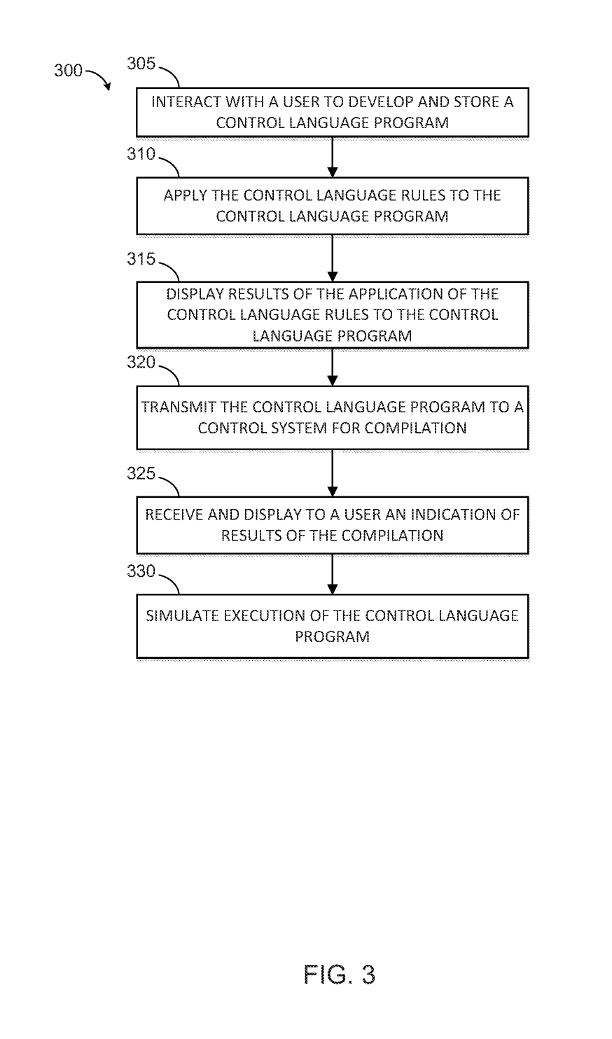

FIG. 3 illustrates a flowchart of a process 300 in accordance with disclosed embodiments, that can be performed, for example, by the IDE system 154 or other data processing system, referred to generically below as the “system” or “IDE system.”

The IDE system interacts with a user to develop and store a control language program (305).

During the interaction, the IDE system applies the control language rules to the control language program to identify at least one of correct syntax, incorrect syntax, semantics, and programming conventions (310). This application can include performing other functions as described herein, such as autocomplete functions.

During the interaction, the IDE system displays, to a user, results of the application of the control language rules to the control language program (315). This can include highlighting the correct syntax, incorrect syntax, semantics, and programming conventions, highlighting related program code or subroutines (such as an entire related code block or calls to code blocks), highlighting specific characters (such as an “close” parenthesis that matches an “open” parenthesis), and others. As part of displaying the results, the IDE system can also provide and display on-line help to the user. As part of displaying the results, the IDE system can also validate external references used in the control language program and visually indicate any errors.

The IDE system can transmit the control language program to a control system for compilation (320).

The IDE system can receive and display to a user an indication of results of the compilation (325). This can include reporting any error codes, success codes, or other results returned from the control system.

The IDE system can simulate execution of the control language program (330). This can be a “real time” simulated execution or a “step through” of the control language program where the simulation processes after executing specific code lines or processes. This can include producing, storing, or displaying the output of the simulated execution.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims. For example, various steps or operations described herein can be performed sequentially, concurrently, or in a different order, or may be omitted or repeated in various embodiments.

What is claimed is:

1. A method comprising:
interacting with a user, by an integrated development environment (IDE) system, to develop and store a control language program in the IDE system;
during the interaction, applying, by the IDE system, one or more control language rules to identify at least one of correct syntax, incorrect syntax, semantics, and programming conventions; and
during the interaction, displaying, to a user and by the IDE system, results of the application of the control language rules to the control language program.

2. The method of claim 1, further comprising:
transmitting, by the IDE system, the control language program to a control system for compilation; and
receiving and displaying to the user, by the IDE system, an indication of a result of the compilation.

3. The method of claim 1, further comprising simulating execution of the control language program by the IDE system.

4. The method of claim 3, wherein the simulation is a step-through simulation of the control language program.

5. The method of claim 1, wherein the IDE system also performs autocomplete functions during the interaction or displays on-line help to a user.

6. The method of claim 1, wherein displaying the results of the application of the control language rules to the control language program includes highlighting the correct syntax, the incorrect syntax, the semantics, and the programming conventions.

7. The method of claim 1, wherein displaying the results of the application of the control language rules to the control language program includes highlighting related program code or subroutines.

8. The method of claim 1, wherein displaying the results of the application of the control language rules to the control language program includes highlighting specific characters.

9. The method of claim 1, wherein the IDE system also performs block collapse and auto-arrange functions for the control language program.

10. An integrated development environment (IDE) system comprising:
a processing device;
a memory;
a user interface; and
a network interface, the IDE system configured to:
interact with a user to develop and store a control language program in the IDE system;
during the interaction, apply one or more control language rules to identify at least one of correct syntax, incorrect syntax, semantics, and programming conventions; and
during the interaction, display results of the application of the control language rules to the control language program.

11. The IDE system of claim 10, wherein the IDE system is further configured to:
transmit the control language program to a control system for compilation; and
receive and display to the user, by the IDE system, an indication of a result of the compilation.

12. The IDE system of claim 10, wherein the IDE system is further configured to:
simulate execution of the control language program by the IDE system.

13. The IDE system of claim 12, wherein the simulation is a step-through simulation of the control language program.

14. The IDE system of claim 10, wherein the IDE system also performs autocomplete functions during the interaction or displays on-line help to a user.

15. The IDE system of claim 10, wherein displaying the results of the application of the control language rules to the control language program includes highlighting the correct syntax, the incorrect syntax, the semantics, and the programming conventions.

16. The IDE system of claim 10, wherein displaying the results of the application of the control language rules to the control language program includes highlighting related program code or subroutines.

17. The IDE system of claim 10, wherein displaying the results of the application of the control language rules to the control language program includes highlighting specific characters.

18. The IDE system of claim 10, wherein the IDE system also performs block collapse and auto-arrange functions for the control language program.

19. A non-transitory machine-readable medium encoded with executable instructions that, when executed, cause one or more processing devices of integrated development environment (IDE) system to:
interact with a user to develop and store a control language program in the IDE system;
during the interaction, apply one or more control language rules to identify at least one of correct syntax, incorrect syntax, semantics, and programming conventions; and
during the interaction, display results of the application of the control language rules to the control language program.

20. The non-transitory machine-readable medium of claim 19, wherein the one or more processing devices are further caused to:
transmit the control language program to a control system for compilation; and
receive and display to the user, by the IDE system, an indication of a result of the compilation.
